(19) United States
(12) Patent Application Publication
(10) Pub. No.: US 2013/0203468 A1
(43) Pub. Date: Aug. 8, 2013

(54) METHODS AND DEVICES FOR MERGING CONTACT RECORDS

(71) Applicant: Jianfeng Weng, Kanata (CA)

(72) Inventor: Jianfeng Weng, Kanata (CA)

(73) Assignee: RESEARCH IN MOTION LIMITED, Waterloo, ON (CA)

(21) Appl. No.: 13/583,249

(22) PCT Filed: Feb. 7, 2012
(86) PCT No.: PCT/CA2012/050067

§ 371 Date: Sep. 7, 2012

(51) Int. Cl. H04M 1/247

(52) U.S. Cl. CPC H04M 1/2477
USPC 455/564

(57) ABSTRACT

Methods and devices for merging contact records are described. In one example aspect, a method includes: determining if an input via the touchscreen display corresponds to a pre-determined merge-contact-record gesture that is a multi-touch gesture that includes a selection of a first interface element and a second interface element, the first interface element being associated with a first contact record and the second interface element being associated with a second contact record; and if the input corresponds to the pre-determined merge-contact-record gesture, merging the first contact record with the second contact record.

### TECHNICAL FIELD

The present application relates to contact information management and more particularly to methods and electronic devices for merging contact records.

### BACKGROUND

Electronic devices such as mobile phones, smart phones, PDAs (personal digital assistants), tablets, etc. are often equipped with an application to store and access contact information. For example, a contact manager application may allow a user to populate a contact record with contact information. The contact manager application may provide contact related functions such as allowing a user input, modify, or view the contact information in a contact record.

The contact manager application typically allows contact records to be created. For example, contact records may be created by manually inputting contact information through an input device associated with the electronic device. Some contact manager applications may allow contact records to be imported by the contact manager application. For example, one or more contact records may be imported from another contact record application or from a file.

In some circumstances, multiple contact records may be created for a single contact. This may occur, for example, when a user imports contact information from multiple sources or when a user imports a contact record for a contact and also manually inputs a contact record for that same contact. As a result, redundant contact records may exist.

### BRIEF DESCRIPTION OF THE DRAWINGS

Reference will now be made, by way of example, to the accompanying drawings which show example embodiments of the present application, and in which:

FIG. 1 is a block diagram illustrating an example electronic device in accordance with example embodiments of the present disclosure;

FIG. 2 is an example display page on a touchscreen display in accordance with example embodiments of the present disclosure;

FIG. 3 is a flowchart illustrating an example method of merging contact records in accordance with example embodiments of the present disclosure;

FIG. 4 is an example merge-contact-record gesture in accordance with example embodiments of the present disclosure;

FIG. 5 is an example display page on the touchscreen display in accordance with example embodiments of the present disclosure;

FIG. 6 is a flowchart illustrating another example method of merging contact records in accordance with example embodiments of the present disclosure; and

FIG. 7 is a flowchart illustrating an example method of receiving a merged-contact-record gesture on the touchscreen display in accordance with example embodiments of the present disclosure.

Like reference numerals are used in the drawings to denote like elements and features.

### DETAILED DESCRIPTION

In one example aspect, the present application describes a method implemented by a processor of an electronic device having a touchscreen display. The method includes: determining if an input via the touchscreen display corresponds to a pre-determined merge-contact-record gesture that is a multi-touch gesture that includes a selection of a first interface element and a second interface element, the first interface element being associated with a first contact record and the second interface element being associated with a second contact record; and if the input corresponds to the pre-determined merge-contact-record gesture, merging the first contact record with the second contact record.

In another example aspect, the present application describes an electronic device. The electronic device includes a memory, a touchscreen display and a processor coupled with the memory and the touchscreen display. The processor is configured for: determining if an input via the touchscreen display corresponds to a pre-determined merge-contact-record gesture, wherein the merge-contact-record gesture is a multi-touch gesture that includes a selection of a first interface element and a second interface element, the first interface element being associated with a first contact record and the second interface element being associated with a second contact record; and if the input corresponds to the pre-determined merge-contact-record gesture, merging the first contact record with the second contact record.

In yet another example aspect, the present application describes a method implemented by a processor of an electronic device having a touchscreen display. The method includes: i) displaying a list of interface elements including a first interface element and a second interface element; ii) receiving a merge-contact-record gesture wherein the merge-contact-record gesture is a multi-touch gesture that includes a selection of the first interface element and the second interface element; iii) merging a first contact record associated with the first interface element with a second contact record associated with the second interface element; and iv) presenting a merged contact record.

Other example embodiments of the present disclosure will be apparent to those of ordinary skill in the art from a review of the following detailed description in conjunction with the drawings.

Example embodiments of the present disclosure are not limited to any particular operating system, electronic device architecture, server architecture or computer programming language.

### Example Electronic Device

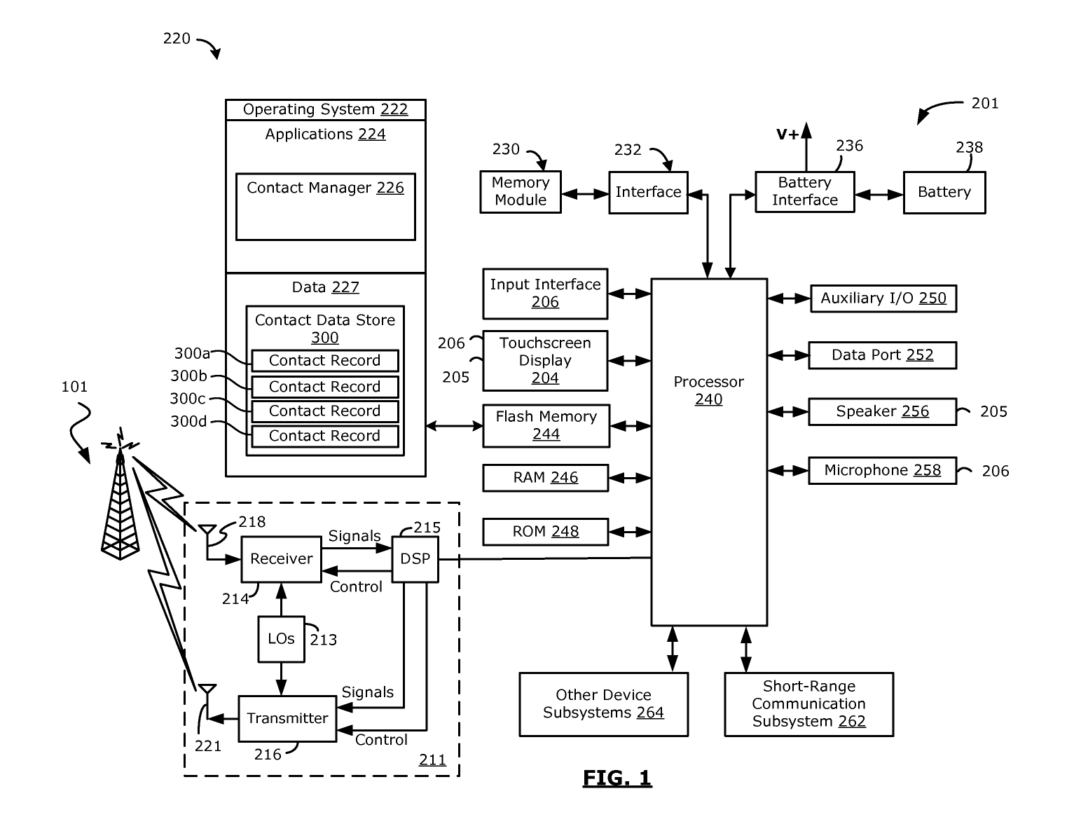

Reference is first made to FIG. 1 which illustrates an example electronic device 201. In the illustrated example embodiment, the electronic device 201 is a communication device, such as a mobile communication device. In at least some example embodiments, the electronic device 201 is a two-way communication device having data and voice communication capabilities, and the capability to communicate with other computer systems, for example, via the Internet. Depending on the functionality provided by the electronic device 201, in various example embodiments the electronic device 201 may be a multiple-mode communication device configured for data and voice communication, a mobile telephone such as a smart phone, a tablet computer such as a slate computer, a wearable computer such as a watch, a PDA (personal digital assistant), or a computer system.

A smartphone is a mobile phone which offers more advanced computing capabilities than a basic non-smartphone cellular phone. For example, a smartphone may have an ability to run third party applications which are stored on the smartphone.

A tablet computer (which may also be referred to as a tablet) is an electronic device 201 which is generally larger than a mobile phone (such as a smartphone) or personal digital assistant. Many mobile phones or personal digital assistants are designed to be pocket sized. That is, mobile phones or personal digital assistants are generally small enough to be carried by a person easily, often in a shirt or pant pocket while tablet computers are larger and may not fit within pant pockets. For example, many tablet computers have a height which is seven inches (7″) or more. In some example embodiments, the tablet computer may be a slate computer. A slate computer is a tablet computer which does not include a dedicated keyboard. A slate computer may allow for text input through the use of a virtual keyboard or an external keyboard which connects to the slate computer via a wired or wireless connection.

In other example embodiments, the electronic device 201 may be of a type not specifically listed above.

The electronic device 201 includes a housing (not shown), housing the components of the electronic device 201. The internal components of the electronic device 201 are constructed on a printed circuit board (PCB). The electronic device 201 includes a controller including at least one processor 240 (such as a microprocessor) which controls the overall operation of the electronic device 201. The processor 240 interacts with device subsystems such as a wireless communication subsystem 211 for exchanging radio frequency signals with a wireless network 101 to perform communication functions. The processor 240 interacts with additional device subsystems including one or more input interfaces 206 (such as a keyboard, one or more control buttons, one or more microphones 258, and/or a touch-sensitive overlay associated with a touchscreen display 204), flash memory 244, random access memory (RAM) 246, read only memory (ROM) 248, auxiliary input/output (I/O) subsystems 250, a data port 252 (which may be a serial data port, such as a Universal Serial Bus (USB) data port), one or more output interfaces 205 (such as the touchscreen display 204, one or more speakers 256, or other output interfaces 205), a short-range communication subsystem 262, and other device subsystems generally designated as 264. Some of the subsystems shown in FIG. 1 perform communication-related functions, whereas other subsystems may provide “resident” or on-device functions.

The electronic device 201 includes a touchscreen display 204. The touchscreen display 204 may be constructed using a touch-sensitive input surface connected to an electronic controller. The touch-sensitive input surface overlays the touchscreen display 204 and may be referred to as a touch-sensitive overlay. The touch-sensitive overlay and the electronic controller provide a touch-sensitive input interface 206 and the processor 240 interacts with the touch-sensitive overlay via the electronic controller. That is, the touchscreen display 204 acts as both an input interface 206 and an output interface 205.

The communication subsystem 211 includes a receiver 214, a transmitter 216, and associated components, such as one or more antenna elements 218 and 221, local oscillators (LOs) 213, and a processing module such as a digital signal processor (DSP) 215. The antenna elements 218 and 221 may be embedded or internal to the electronic device 201 and a single antenna may be shared by both receiver 214 and transmitter 216. The particular design of the wireless communication subsystem 211 depends on the wireless network 101 in which the electronic device 201 is intended to operate.

The electronic device 201 may communicate with any one of a plurality of fixed transceiver base stations of the wireless network 101 within its geographic coverage area. The electronic device 201 may send and receive communication signals over the wireless network 101 after the required network registration or activation procedures have been completed. Signals received by the antenna 218 through the wireless network 101 are input to the receiver 214, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 215. In a similar manner, signals to be transmitted are processed, including modulation and encoding, for example, by the DSP 215. These DSP-processed signals are input to the transmitter 216 for digital-to-analog (D/A) conversion, frequency up conversion, filtering, amplification, and transmission to the wireless network 101 via the antenna 221. The DSP 215 not only processes communication signals, but may also provide for receiver and transmitter control. For example, the gains applied to communication signals in the receiver 214 and the transmitter 216 may be adaptively controlled through automatic gain control algorithms implemented in the DSP 215.

In some example embodiments, the auxiliary input/output (I/O) subsystems 250 may include an external communication link or interface, for example, an Ethernet connection. The electronic device 201 may include other wireless communication interfaces for communicating with other types of wireless networks, for example, a wireless network such as an orthogonal frequency division multiplexed (OFDM) network. The auxiliary I/O subsystems 250 may include a pointing or navigational tool (input device) such as a clickable trackball or scroll wheel or thumbwheel, or a vibrator for providing vibratory notifications in response to various events on the electronic device 201 such as receipt of an electronic message or incoming phone call, or for other purposes such as haptic feedback (touch feedback).

In some example embodiments, the electronic device 201 also includes a removable memory module 230 (typically including flash memory) and a memory module interface 232. Network access may be associated with a subscriber or user of the electronic device 201 via the memory module 230, which may be a Subscriber Identity Module (SIM) card for use in a GSM network or other type of memory module for use in the relevant wireless network. The memory module 230 may be inserted in or connected to the memory module interface 232 of the electronic device 201.

The electronic device 201 may store data 227 in an erasable persistent memory, which in one example embodiment is the flash memory 244. In various example embodiments, the data 227 may include service data having information required by the electronic device 201 to establish and maintain communication with the wireless network 101. The data 227 may also include user application data such as email messages, address book and contact information, calendar and schedule information, notepad documents, image files, and other commonly stored user information stored on the electronic device 201 by its user, and other data. The data 227 stored in the persistent memory (e.g. flash memory 244) of the electronic device 201 may be organized, at least partially, into a number of databases or data stores each containing data items of the same data type or associated with the same application. For example, email messages, contact records 300a, 300b, 300c, 300d, and task items may be stored in individual databases within the memory of the electronic device 201. By way of example, contact records 300a, 300b, 300c, 300d may be stored in a contact data store 300 which may be a database which is configured for storing the contact records.

The data port 252 may be used for synchronization with a user's host computer system (not shown). The data port 252 enables a user to set preferences through an external device or software application and extends the capabilities of the electronic device 201 by providing for information or software downloads to the electronic device 201 other than through the wireless network 101. The alternate download path may, for example, be used to load an encryption key onto the electronic device 201 through a direct, reliable and trusted connection to thereby provide secure device communication.

In some example embodiments, the electronic device 201 is provided with a service routing application programming interface (API) which provides an application with the ability to route traffic through a serial data (i.e., USB) or Bluetooth® (Bluetooth® is a registered trademark of Bluetooth SIG, Inc.) connection to the host computer system using standard connectivity protocols. When a user connects their electronic device 201 to the host computer system via a USB cable or Bluetooth® connection, traffic that was destined for the wireless network 101 is automatically routed to the electronic device 201 using the USB cable or Bluetooth® connection. Similarly, any traffic destined for the wireless network 101 is automatically sent over the USB cable Bluetooth® connection to the host computer system for processing.

The electronic device 201 also includes a battery 238 as a power source, which is typically one or more rechargeable batteries that may be charged, for example, through charging circuitry coupled to a battery interface 236 such as the serial data port 252. The battery 238 provides electrical power to at least some of the electrical circuitry in the electronic device 201, and the battery interface 236 provides a mechanical and electrical connection for the battery 238. The battery interface 236 is coupled to a regulator (not shown) which provides power V+ to the circuitry of the electronic device 201.

The short-range communication subsystem 262 is an additional optional component which provides for communication between the electronic device 201 and different systems or devices, which need not necessarily be similar devices. For example, the short-range communication subsystem 262 may include an infrared device and associated circuits and components, or a wireless bus protocol compliant communication mechanism such as a Bluetooth® communication module to provide for communication with similarly-enabled systems and devices.

A pre-determined set of applications that control basic device operations, including data and possibly voice communication applications will normally be installed on the electronic device 201 during or after manufacture. Additional applications and/or upgrades to an operating system 222 or software applications 224 may also be loaded onto the electronic device 201 through the wireless network 101, the auxiliary I/O subsystem 250, the data port 252, the short-range communication subsystem 262, or other suitable device subsystems 264. The downloaded programs or code modules may be permanently installed, for example, written into the program memory (i.e. the flash memory 244), or written into and executed from the RAM 246 for execution by the processor 240 at runtime.

In some example embodiments, the electronic device 201 may provide two principal modes of communication: a data communication mode and a voice communication mode. In the data communication mode, a received data signal such as a text message, an email message, or a web page download will be processed by the communication subsystem 211 and input to the processor 240 for further processing. For example, a downloaded web page may be further processed by a browser application or an email message may be processed by the email messaging application and output to the touchscreen display 204. A user of the electronic device 201 may also compose data items, such as email messages, for example, using the input devices, such as the touchscreen display 204. These composed items may be transmitted through the communication subsystem 211 over the wireless network 101.

In the voice communication mode, the electronic device 201 provides telephony functions and operates as a typical cellular phone. The overall operation is similar to the data communication mode, except that the received signals would be output to the speaker 256 and signals for transmission would be generated by a transducer such as the microphone 258. The telephony functions are provided by a combination of software/firmware (i.e., a voice communication module) and hardware (i.e., the microphone 258, the speaker 256 and input devices). Alternative voice or audio I/O subsystems, such as a voice message recording subsystem, may also be implemented on the electronic device 201. Although voice or audio signal output is typically accomplished primarily through the speaker 256, the touchscreen display 204 may also be used to provide an indication of the identity of a calling party, duration of a voice call, or other voice call related information.

The processor 240 operates under stored program control and executes software modules 220 stored in memory such as persistent memory, for example, in the flash memory 244. As illustrated in FIG. 1, the software modules 220 include operating system software 222, and software applications 224 including a contact manager 226. In the example embodiment of FIG. 1, the contact manager 226 is implemented as a separate stand-alone application 224, but in other example embodiments, the contact manager 226 may be implemented as part of the operating system 222 or another application 224.

The electronic device 201 may include a range of additional software applications 224, including, for example, a notepad application, a voice communication (i.e. telephony) application, a mapping application, or a media player application, or any combination thereof. Each of the software applications 224 may include layout information defining the placement of particular fields and graphic elements (e.g. text fields, input fields, icons, etc.) in the user interface (i.e. the touchscreen display 204) according to the application. In at least some example embodiments, the software applications 224 may include pre-determined gesture information defining functionalities associated with the pre-determined gestures received via the touchscreen display 204. For example, a software application 224 may determine a finger swiping movement (i.e. a pre-determined gesture) on the touchscreen display 204 as a scrolling function.

The software modules 220 or parts thereof may be temporarily loaded into volatile memory such as the RAM 246. The RAM 246 is used for storing runtime data variables and other types of data or information. Although specific functions are described for various types of memory, this is merely one example, and a different assignment of functions to types of memory could also be used.

The contact manager 226 performs the functions of an address book and allows contact records 300a, 300b, 300c, 300d to be created and stored in memory. For example, the contact manager 226 may permit contact records 300a, 300b, 300c, 300d to be stored in a contact data store 300 in the data area 227 of memory.

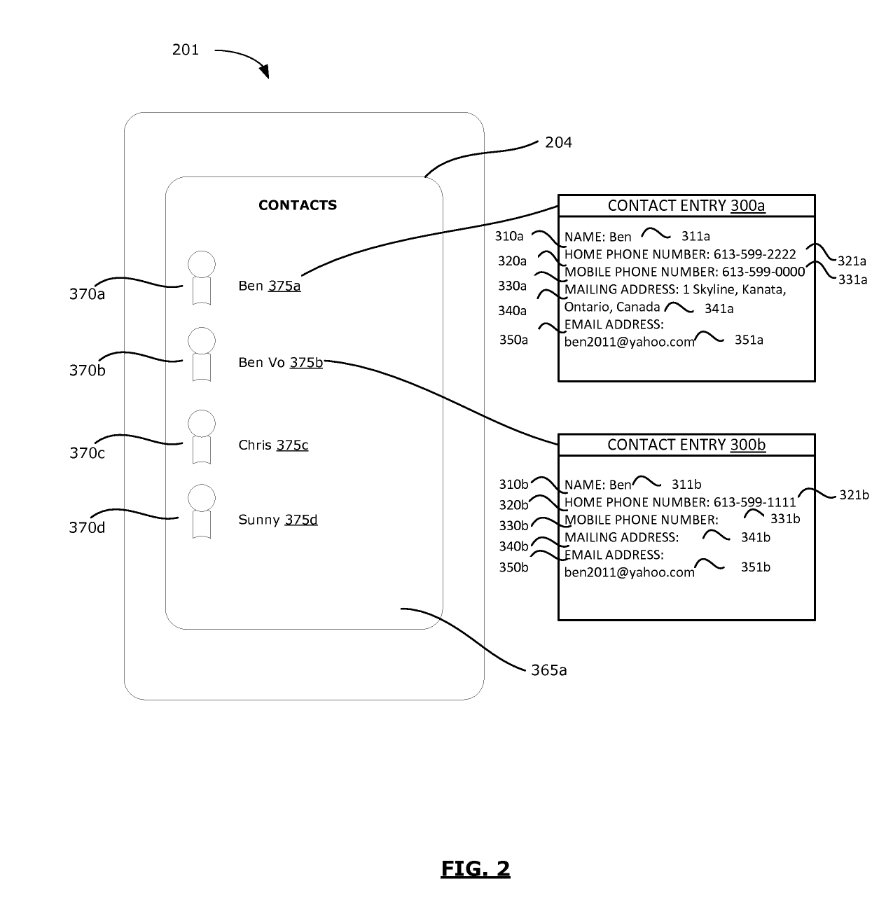

Contact records 300a, 300b, 300c, 300d are records which store contact information for a contact. The contact may, for example, be a person or business associated with a user of the electronic device 201. Contact records 300a, 300b, 300c, 300d may include information such as identifying information for a contact. The identifying information may include, for example, one or more names, phone numbers, mailing addresses and/or electronic messaging addresses associated with the contact. An example contact record will be discussed in greater detail below with reference to FIG. 2.

The contact manager 226 is configured to receive new contact records 300a, 300b, 300c, 300d from one or more input interfaces 206 associated with the electronic device 201. For example, a user of the electronic device 201 may interact with an input interface 206 (for example, the touchscreen display 204) in order to input an instruction to the contact manager 226 to create a new contact record 300a, 300b, 300c, 300d. Similarly, in at least some example embodiments, the contact manager 226 is configured to receive contact records 300a, 300b, 300c, 300d via the communication subsystem 211. For example, in some example embodiments, a contact record 300a, 300b, 300c, 300d may be received in an electronic message, such as an email. The contact manager 226 may store contact records 300a, 300b, 300c, 300d received via an input interface 206 or a communication subsystem 211 in the contact data store 300. Such storage may occur automatically or at the request of the user (e.g. by selecting an option to store a contact record 300a, 300b, 300c, 300d to memory such as a “save” option).

The contact manager 226 may be configured to permit contact records to be created in other ways apart from those mentioned above. For example, in some example embodiments, the contact manager 226 may allow one or more contact records 300a, 300b, 300c, 300d to be imported from another application and/or file.

In at least some example embodiments, after contact records 300a, 300b, 300c, 300d are created they may be accessed by the contact manager 226. In at least some example embodiments, contact records 300a, 300b, 300c, 300d may be accessed by other applications 224. For example, in at least some example embodiments, some applications 224 may access the contact records 300a, 300b, 300c, 300d directly. In other example embodiments, the contact manager 226 may control access to the contact records 300a, 300b, 300c, 300d. In at least some such example embodiments, other applications 224 may access the contact records 300a, 300b, 300c, 300d by requesting access from the contact manager 226. For example, in at least some example embodiments, the contact manager 226 may be equipped with an application programming interface (API) which allows other applications to request information associated with contact records 300a, 300b, 300c, 300d. In response to receiving such requests via an API, the contact manager 226 may retrieve the requested information and provide the information to the requesting application 224.

In the example illustrated, four contact records are shown including a first contact record 300a, a second contact record 300b, a third contact record 300c, and a fourth contact record 300d. However, the contact data store 300 may store more or less contact records 300a, 300b, 300c, 300d than are shown in FIG. 1.

The contact records 300a, 300b, 300c, 300d may be received and/or stored in vCard format or in another format which describes contact information.

In at least some example embodiments, the contact manager 226 may include pre-determined gesture information defining functionalities associated with one or more pre-determined gestures received via the touchscreen display 204. The pre-determined gestures may include single touch and multi-touch gestures such as swiping movements, flicking movements, press and drag movements, circular movements, etc. The contact manager 226 may associate a specific gesture with a particular function. For example, the contact manager 226 may associate a received swiping movement via the touchscreen display 204 as a scrolling function. That is, the contact manager 226 may be configured to perform a scrolling function in response to receiving a swiping movement.

In at least some example embodiments, the pre-determined gestures defining associated functionalities are stored in the data area 227 of the memory. The contact manager 226 has access to the stored pre-determined gesture information, and may retrieve the pre-determined gesture information in response to receiving a gesture via the touchscreen display 204. In at least some example embodiments, other applications 224 may have access to the pre-determined gesture information either directly or indirectly. In some example embodiments, modules associated with the contact manager 226 may have access to the pre-determined gesture information.

The contact manager 226 may be configured to merge two or more contact records. In such example embodiments, the contact manger 226 may be configured to determine if an input via the touchscreen display 204 corresponds to a pre-determined merge-contact-record gesture, and, if so, merging a first contact record with a second contact record to form a merged contact record. The pre-determined merge-contact-record gesture is a multi-touch gesture, and includes a selection of a first interface element and a second interface element. The first interface element is associated with the first contact record and the second interface element is associated with the second contact record. Specific functions and features of the contact manger 226 will be discussed in greater detail below with reference to FIGS. 2 to 7.

In at least some example embodiments, the operating system 222 may perform some or all of the functions of the contact manager 226. In other example embodiments, the functions or a portion of the functions of the contact manager 226 may be performed by one or more other applications. Further, while the contact manager 226 has been illustrated as a single block, the contact manager 226 may include a plurality of software modules. In at least some example embodiments, these software modules may be divided among multiple applications.

### Example Display Page

Reference is next made to FIG. 2 which shows an example display page 365a which may be displayed on the touchscreen display 204 of the electronic device 201. The display page 365a may be provided by the contact manager 226. The display page 365a includes a list of interface elements 370a, 370b, 370c, 370d that are each associated with a contact identifier 375a, 375b, 375c, 375d. An interface element is a user selectable portion of the touchscreen display 204. The interface elements may, for example, include a button, icon, text, hyperlink, area nearby the contact identifier 375a, 375b, 375c, 375d, or another portion which may be selected and which is associated with a contact record. The contact identifiers 375a, 375b, 375c, 375d may be user defined, and may be identified, for example, by a personal name or a company name. The contact identifiers 375a, 375b, 375c, 375d and the associated interface elements 370a, 370b, 370c, 370d may be arranged on the display page 365a based on user defined preferences. For example, in at least some example embodiments, the contact identifiers 375a, 375b, 375c, 375d may be arranged alphabetically. The interface elements 370a, 370b, 370c, 370d for contacts may each be associated with a separate contact record 300a, 300b, 300c, 300d.

In at least one operating mode, a pre-determined gesture or input associated with an interface element 370a, 370b, 370c, 370d may cause the electronic device 201 to display an associated contact record 300a, 300b, 300c, 300d for that interface element 370a, 370b, 370c, 370d. In at least some example embodiments, the pre-determined gesture may be a gesture associated with the touchscreen display 204, for example a tapping gesture. The contact manager 226 may be configured to determine and respond to the pre-determined gesture. In response to receiving the selection, in at least some example embodiments, the contact record 300a, 300b, 300c, 300d associated with the input may be displayable on a different display page. In at least some example embodiments, the selected contact record 300a, 300b, 300c, 300d may be displayable on the same display page 365a as the list of interface elements 370a, 370b, 370c, 370d.

The contact record 300a, 300b, 300c, 300d may include contact information associated with a contact. A contact is an entity such as a person or business which is associated with a user of the electronic device 201.

The contact record 300a, 300b, 300c, 300d includes a plurality of fields, including, for example, one or more name fields 310a, 310b (which may store a name 311a, 311b of a contact such as a personal name (e.g. a first name, middle name, last name, and/or nickname, etc.), or a company name of a contact), one or more phone number field for storing a phone number such as a home phone number field 320a, 320b (which may store one or more home phone number 321a, 321b associated with a contact) and/or one or more mobile phone number field 330a, 330b (which may store one or more mobile phone number 331a, 331b associated with a contact), a mailing address field 340a, 340b (which may store a residential or business address 341a, 341b associated with a contact) and an electronic messaging address field 350a, 350b (which may store an electronic messaging address for a contact, such as an email address 351a, 351b). The contact record 300a, 300b, 300c, 300d may also include other fields for storing other contact information not specifically listed above.

### Merging Contact Records

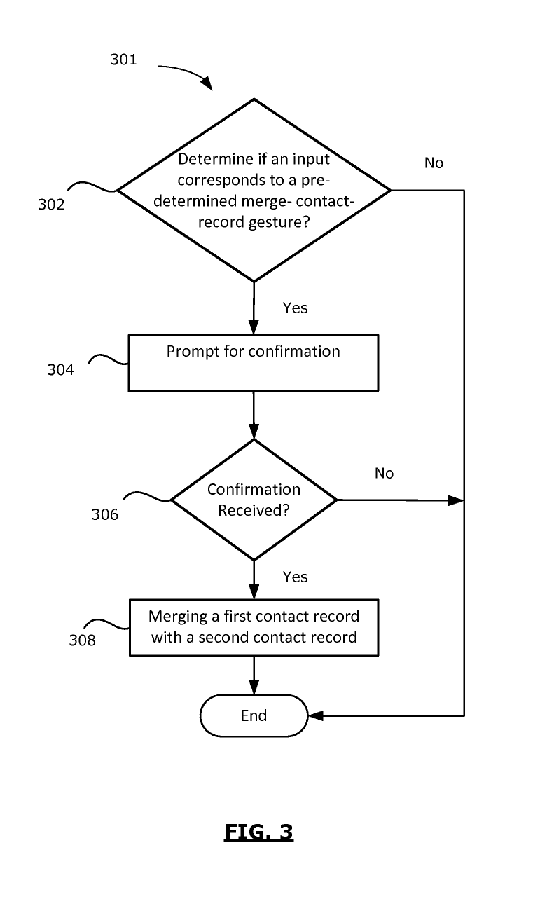

Referring now to FIG. 3, a flowchart of an example method 301 of merging contact records 300a, 300b, 300c, 300d is illustrated. The electronic device 201 (FIG. 1) may be configured to perform the method 301 of FIG. 3. In at least some example embodiments, the processor 301 of the electronic device 201 is configured to perform the method 301 of FIG. 3. One or more applications 224 (FIG. 1) or modules on the electronic device 201 (FIG. 1) may contain computer readable instructions which cause the processor 240 (FIG. 1) of the electronic device 201 to perform the method 301 of FIG. 3. In at least some example embodiments, the contact manager 226 (FIG. 1) stored in memory of the electronic device 201 is configured to perform the method 301 of FIG. 3. More particularly, the contact manager 226 may contain computer readable instructions which, when executed, cause the processor 240 to perform the method 301 of FIG. 3. It will be appreciated that the method 301 of FIG. 3 may, in at least some example embodiments, be provided by other software applications or modules apart from those specifically discussed above, such as the operating system 222. Accordingly, any features which are referred to as being performed by the electronic device 201 may be performed by any one or more of the software applications or modules referred to above or other software modules.

In at least some example embodiments, at least some of the method 301 of FIG. 3 may be performed by or may rely on other applications 224 or modules which interface with the contact manager 226. For example, the contact manager 226 may be equipped with an application programming interface (API) which allows other software applications 224 or modules to access features of the contact manager 226.

Referring to FIG. 3, a flowchart of an example method 301 of merging contact records 300a, 300b, 300c, 300d is illustrated. At 302, the contact manager 226 determines if an input via the touchscreen display 204 corresponds to a pre-determined merge-contact-record gesture. In at least some example embodiments, the input may be received by a finger, hand and/or other physical body part gesture on the touchscreen display 204. In at least some example embodiments, the input may be received by an input device, such as a stylus, at the touchscreen display 204.

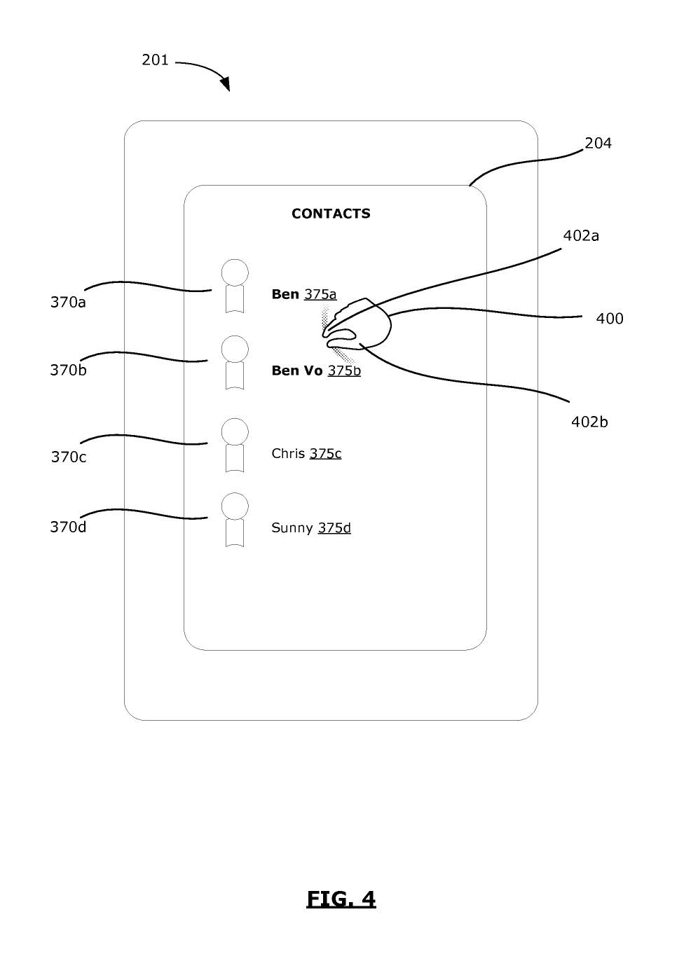

The merge-contact-record gesture is a multi-touch gesture which includes a selection of a first interface element 370a and a second interface element 370b. The first interface element 370a is associated with a first contact record 300a, and the second interface element 370b is associated with a second contact record 300b. In at least some example embodiments, the multi-touch gesture may include a pinching movement. An example multi-touch merge-contact-record gesture will be discussed below with reference to FIG. 4.

In determining if an input corresponds to a pre-determined merge-contact-record gesture, in at least some example embodiments, the contact manager 226 may compare the received gesture to a list of pre-determined gestures, and determine if the received gesture matches to at least one gesture corresponding to merge functionalities. As stated above, the contact manager 226 may include pre-determined gestures that correspond to associated functionalities. For example, a clockwise circular touch movement may be associated with a zoom-in function, and an anti-clockwise touch movement may be associated with a zoom-out function. In at least some example embodiments, the pre-determined gestures defining associated functions may be stored in the data area 227 of the memory of the electronic device 201. In such example embodiments, the contact manager 226 may retrieve the stored pre-determined gestures from the data 227 area of memory, and compare the received gesture to retrieved pre-determined gestures, and determine if the received gesture matches at least one pre-determined gesture corresponding to merge functionalities. That is, the electronic device 201 determines whether the received input corresponds to a gesture which has been designated as the merge-contact-record gesture.

In at least some example embodiments, the pre-determined merge-contact-record gesture is a pinching movement. In such example embodiments, the contact manager 226 compares and determines if the received gesture corresponds to a pinching movement.

If the input does not correspond to the merge-contact-record gesture, then another function may be performed if the received input corresponds to another gesture which has an associated function.

After determining that the input via the touchscreen display 204 corresponds to a pre-determined merge-contact-record gesture, the contact manager 226 may, in some example embodiments, at 304, present a prompt via the touchscreen display 204 to request confirmation to merge the first contact record 300a that is associated with the first contact identifier 375a with the second contact record 300b that is associated with the second contact identifier 375b. The prompt may, in various example embodiments, ask the user to confirm, cancel, or modify merging of the first contact record 300a with the second contact record 300b. Accordingly, in at least some example embodiments, in response to determining that the input corresponds to the pre-determined merge-contact-record gesture, the electronic device 201 may present the prompt.

Next, at 306, the contact manager may determine whether confirmation to merge the record has been received via the touchscreen display 204. In at least some example embodiments, the confirmation may be received by performing a pre-determined selection-of-confirmation gesture on the touchscreen display 204. In at least some example embodiments, the gesture may include a tapping movement on an interface element corresponding to a confirmation of merging of the first contact record 300a with the second contact record 300b. In some example embodiments, if no confirmation is received at 306 (for example, if the user instructs the contact manager 226 not to merge the first contact record with the second contact record by selecting an interface element corresponding to not merge the contact records), then the method 301 ends without merging the first contact record 300a with the second contact record 300b.

In at least some example embodiments, after having received confirmation, the contact manager 226, at 308, merges the first contact record 300a associated with the first contact identifier 375a with the second contact record 300b associated with the second contact identifier 375b forming a merged contact record.

In at least some example embodiments, the merging function includes selectively using data from the first contact record 300a and the second contact record 300b based on one or more pre-determined rules. In such example embodiments, the contact manager 226, in merging the first contact record 300a with the second contact record 300b, may determine if the information in a first field 310a, 320a, 330a, 340a, 350a in the first contact record 300a is the same as the information in an associated second field 310b, 320b, 330b, 340b, 350b in the second contact record 300b. For example, the contact manager 226 may compare the information in the first electronic messaging address field 350a in the first contact record 300a with the information in the second electronic messaging address field 350b in the second contact record 300b.

If the contact manager 226 determines that the information in a first field 310a, 320a, 330a, 340a, 350a in the first contact record 300a is the same as the information in an associated second field 310b, 320b, 330b, 340b, 350b in the second contact record 300b, the contact manager 226 may populate an associated merged field in the merged contact record with the information from the compared fields from either the first contact record 300a or the second contact record 300b. For example, if the information in the first electronic messaging address field 350a in the first contact record 300a is the same as the information in the second electronic messaging address field 350b in the second contact record (i.e. the first contact record 300a and the second contact record 300b have the same email addresses 351a, 351b), the contact manager 226 populates a merged email address field in the merged contact record with the email address 351a, 351b stored in the email address field 350a, 350b of either the first contact record 300a or the second contact record 300b.

If however, the contact manager 226 determines that the information in a first field 310a, 320a, 330a, 340a, 350b in the first contact record 300a is not the same as the information in an associated second field 310b, 320b, 330b, 340b, 350b in the second contact record 300b, the contact manager 226 may populate an associated merged field in the merged contact record with the information from both the compared fields in the first contact record 300a and the second contact record 300b. For example, if the information in the first home phone number field 320a in the first contact record 300a is different than the information in the second home phone number field 320b in the second contact record 300b (i.e. the first contact record 300a and the second contact record 300b have different home phone numbers 321a, 321b), the contact manager 226 may populate a merged home phone number field in the merged contact record with both home phone numbers 321a, 321b stored in the home phone number fields 320a, 320b of the first contact record 300a and the second contact record 300b.

In at least some example embodiments, if it is determined that the information in a first field 310a, 320a, 330a, 340a, 350a in the first contact record 300a is not the same as the information in an associated second field 310b, 320b, 330b, 340b, 350b in the second contact record 300b, the contact manager 226 may create a plurality of sub-fields associated with the compared fields of the first contact record 300a and the second contact record 300b, in the merged contact record. Each sub-field is populated with information from a compared field in the first contact record 300a and the second contact record 300b. For example, if the information in the first home phone number field 320a in the first contact record 300a is different than the information in the second home phone number field 320b in the second contact record 300b (i.e. the first contact record 300a and the second contact record 300b have different home phone numbers 321a, 321b), the contact manager 226 may create a first merged home phone number sub-field and a second merged home phone number sub-field in the merged contact record. The first merged home phone number sub-field may be populated with the home phone number 321a in the first home phone number field 320a of the first contact record 300a, and the second merged home phone number sub-field may be populated with the home phone number 321b in the second home number field 320b of the second contact record 300b.

In at least some example embodiments, if it is determined that the information in a first field 310a, 320a, 330a, 340a, 350a in the first contact record 300a is not the same as the information in an associated second field 310b, 320b 330b, 340b, 350b in the second contact record 300b, then the contact manager 226 may select the information from one of either the first field in the first contact record or the second field in the second contact record. That is, in some embodiments, the information from one of these fields may be included and the information from another of these fields may be discarded. The selection may be performed in accordance with one or more pre-determined rules and/or user input. For example, in some example embodiments, the contact record having the highest number of completed fields may overrule the contact record having the least number of completed fields. That is, information from the contact record which is considered to be the most complete may be selected.

In at least some example embodiments, the merged contact record may be associated with a merged contact identifier. The merged contact identifier may be an identifier, such as a name which identifies the contact associated with the merged contact record. The merged contact identifier may be displayable on the touchscreen display 204 as part of an interface element. After the merging is completed, the interface element associated with the merged contact record may be selected to access the associated merged contact record. In at least some example embodiments, the merged contact record is stored in the memory, for example the flash memory 244 of the electronic device 201. In at least some example embodiments, the merged contact record is stored in the data area 227, such as the contact data store 300, of the electronic device 201.

In at least some example embodiments, after merging the first contact record 300a with the second contact record 300b, the contact manager 226 no longer displays on the touchscreen display 204 the first interface element 370a associated with the first contact record 300a and the second interface element 370b associated with the second contact record 300b.

In at least some example embodiments, during the merging at 308, the contact manager 226 may remove the first contact record 300a and the second contact record 300b from memory (for example, from the contact data store 300 of the electronic device 201).

In at least some example embodiments, the multi-touch gesture includes a selection of three or more interface elements 370a, 370b, 370c, 370d for merging. That is, a user may perform a multi-touch gesture to merge three or more contact records 300a, 300b, 300c, 300d simultaneously. In such example embodiments, the contact manager 226 may determine if the multi-touch gesture involving a selection of three or more interface elements 370a, 370b, 370c, 370d associated with three or more contact records corresponds to a pre-determined merge-contact-record gesture. If the contact manager 226, determines that the multi-touch gesture corresponds to a pre-determined merge-contact-record gesture, the contact manager 226 merges the three or more contact records 300a, 300b, 300c, 300d associated with the selected three or more interface elements 370a, 370b, 370c, 370d.

In at least some example embodiments, such as the example embodiment illustrated in FIG. 3, further user input is required from the user via the touchscreen display 204 in order to merge the first contact record 300a with the second contact record 300b, after the contact manager 226 determines that the input corresponds to a pre-determined merge-contact-record gesture (e.g. a prompt is displayed at 304 and confirmation is required at 306). However, in other example embodiments, the contact manager 226 may automatically merge the first contact record 300a with the second contact record 300b after determining that the input corresponds to a pre-determined merge-contact-record gesture. That is, the contact manager 226 performs the merge function without the need for a prompt, confirmation and/or further input from the user.

### Merge-Contact-Record Gesture

Referring next to FIG. 4, which illustrates an example merge-contact record-gesture 400. The merge-contact-record gesture 400 is a multi-touch gesture which includes a selection of a first interface element 370a associated with a first contact identifier 375a and a second interface element 370b associated with a second contact identifier 375b (for merging associated first contact record 300a with second contact record 300b).

In at least some example embodiments, the multi-touch gesture is a pinching movement. In such example embodiments, the pinching movement starts with at least two fingers 402a, 402b spaced apart and ends with the two fingers 402a, 402b relatively closer than when starting the movement, as illustrated in FIG. 4. The movement may start by placing a first finger 402a on the first interface element 370a and a second finger 402b on the second interface element 370a in order to select the first interface element 370a and the second interface element 370b. In at least some example embodiments, selecting the first interface element 370a and the second interface element 370a may graphically change the display of the first interface element 370a and the second interface element 370b, and/or the associated first contact identifier 375a and the second contact identifier 375b displayed on the touchscreen display 204. For example, a selection of the first interface element 370a and the second interface element 370b may graphically bolden, color, highlight or outline, the first interface element 370a and/or the second interface element 370b, or the associated first contact identifier 375a and second contact identifier 375b. In at least some example embodiments, a selection of the first interface element 370a and the second interface element 370b may highlight the interface elements 370a, 370b. The first finger 402a and the second finger 402b are each then moved closer together. Movement of the first finger 402a and second finger 402b may be stopped when a pre-defined threshold distance between the first finger 402a and the second finger 402b is reached. When the pre-defined threshold distance is reached, the first finger 402a and the second finger 402b are relatively closer than when starting the movement. The pre-threshold distance may be a pre-determined distance recognized by the contact manager 226 as corresponding to the pre-determined merge-contact-record gesture 400.

In at least some example embodiments, the pinching movement is a movement which starts with at least two fingers 402a, 402b spaced apart and ends with the two fingers 402a, 402b almost touching, touching, with little or no space between the two fingers 402a, 402b. The movement may start by placing the first finger 402a on the first interface element 370a and the second finger 402b on the second interface element 370b. The first finger 402a and the second finger 402b are each then moved closer together until the first finger 402a almost touches or touches the second finger 402b, and there is little or no space between the first finger 402a and the second finger 402b.

In at least some example embodiments, the pinching movement associated with the merge-contact-record gesture is a movement of each of the two fingers 402a, 402b (as illustrated in the example of FIG. 4). That is, the first finger 402a and the second finger 402b are each moved in performing the pinching movement. In at least some example embodiments, the pinching movement associated with the merge-contact-record gesture is a movement of only one finger. That is, either the first finger 402a or the second finger 402b is only moved in performing the pinching movement.

In at least some example embodiments, the multi-touch gesture associated with the merge-contact-record gesture is a three finger closing movement (not shown). The three finger closing movement begins with three fingers spaced apart and ends with the three fingers almost touching or touching, with little or no space between the three fingers. In such example embodiments, the three finger closing movement may include a selection of three interface elements 370a, 370b, 370c for merging. In at least some example embodiments, the movement may start by placing a first finger on a first interface element 370a, a second finger on a second interface element 370b and a third finger on a third interface element 370c to select three interface elements 370a, 370b, 370c associated with three contact records. For example, the second finger may be located between the first finger and the third finger. The first finger and the third finger are each then moved closer together towards the second finger until the three fingers are almost touching or touching with little or no space between the three fingers.

In at least some example embodiments, the three finger closing movement begins with three fingers spaced apart and ends with the three fingers relatively closer than when starting the movement. In at least some example embodiments, the three finger closing movement may include a selection of three interface elements 370a, 370b, 370c for merging. In some such example embodiments, the movement may start by placing a first finger on a first interface element 370a, a second finger on a second interface element 370b and a third finger on a third interface element 370c for selecting three interface elements 370a, 370b, 370c. The second finger may be located in between the first finger and the second finger. The first finger and the third finger are each then moved closer together towards the second finger. Movement of the first finger and the third finger may be stopped when a pre-determined threshold distance between the three fingers is reached. When the pre-determined threshold distance is reached, the three fingers are relatively closer to each other than when starting the movement. The pre-determined threshold distance may be a pre-determined distance recognized by the contact manager 226 as corresponding to an operation of the pre-determined merge-contact record-gesture 400.

Although the merge-contact-record gesture is illustrated in relation to finger movements, it will be appreciated that the merge-contact-record gesture 400 may be performed by other body parts and/or passive objects, such as styluses, on the touchscreen display 204.

### Merged Contact Record

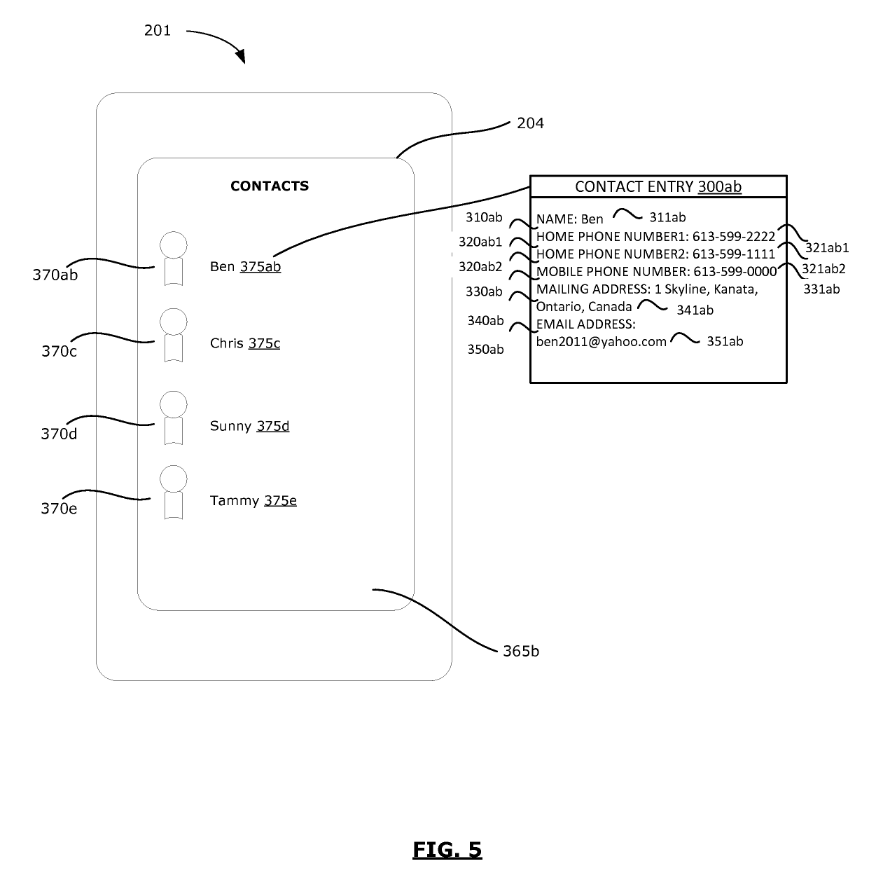

Referring next to FIG. 5, another example display page 365b of the touchscreen display 204 is illustrated. The new display page 365b includes a new list of interface elements 370ab, 370c, 370d, 370e and associated contact identifiers 375ab, 375c, 375d, 375e. The new display page 365b includes a merged interface element 370ab associated with a merged contact identifier 375ab (the merged contact identifier 375ab may be user defined during the merge process described above); a third interface element 370c associated with a third contact identifier 375c (same as FIG. 2), a fourth interface element 370d associated with a fourth contact identifier 375d (same as FIG. 2) and a fifth interface element 370e associated with a fifth contact identifier 375e. The merged contact identifier 375ab is associated with the merged contact record 300ab. The merged contact record 300ab is a merger of the first contact record 300a and the second contact record 300b. As a result of the merger, the first contact identifier 370a and the second contact identifier 370b are no longer displayed (as in FIG. 2). The fifth contact identifier 375e is now displayed (The fifth contact identifier may not have been displayed in FIG. 2 because, for example, the display page 365b may be configured to display a maximum of four contact identifiers). Accordingly, the new display page 365b illustrates the result of the merging of FIG. 3.

As noted above, a selection of the merged interface element 370ab may display the associated merged contact record 300ab on the new display page 365b or on a different display page. The merged contact record 300ab includes a merged name field 310ab storing a personal name (or a company name) 311ab, a first merged home phone number sub-field 320ab1 storing a first home phone number 321ab1, a second merged home phone number sub-field 320ab2 storing a second home phone number 321ab2, a merged mobile phone number field 330ab storing a mobile phone number 331ab, a merged mailing address field 340ab storing a residential or business mailing address 341ab, and a merged electronic messaging address field 350ab storing an email address 351ab.

As noted above with respect to FIG. 3, if the contact records being merged contained corresponding fields which contained different information, then the merged contact record may be created to include the information from both fields. For example, if the home phone number 321a in the first home phone number field 320a of the first contact record 300a is different than the home phone number 321b in the second home phone number field 320b of the second contact record 300b, in at least some example embodiments, the merged contact record 300ab includes a first merged home phone number sub-field 320ab1 and a second merged home phone number sub-field 320ab2. The first merged home phone number sub-field 320ab1 is populated with the home phone number 321a in the first home phone number field 320a of the first contact record 300a, and the second merged home phone number sub-field 320ab2 is populated with the home phone number 321b in the second home phone number field 320b of the second contact record 300b.

In the illustrated example, the mobile phone number 331ab in the merged mobile phone number field 330ab of the merged contact record 300ab is populated with the mobile phone number 331a in the first mobile phone number field 330a of the first contact record 300a as the second mobile phone number field 330b of the second contact record 300b does not include any information (i.e. the second mobile phone number field 330b does not store a mobile phone number 331b). Similarly, the mailing address 341ab in the merged mailing address field 340ab of the merged contact record 300ab is populated with the mailing address 341b in the second mailing address field 340b of the second contact record 300b as the first mailing address field 340a of the first contact record 300a does not include any information (i.e. the first mailing address field 340a does not store a mailing address 341a). The email address 341ab in the merged electronic messaging address field 340ab of the merged contact 300ab is populated with the email address 351a in the first electronic messaging address field 350a of the first contact record 300a, or the email address 351b in the second electronic messaging address field 350b of the second contact record 300b as the email addresses 351a, 351b are the same.

### Multiple-Contact-Locator Navigation Gestures

In some cases, a user may wish to merge two or more contact records which are associated with two or more interface elements which are not displayed on the same page. In at least some example embodiments, to allow a user to merge contact records in such a scenario, a multiple-contact-locator navigation gesture may be performed. Examples of such gestures, and their effect will now be described.

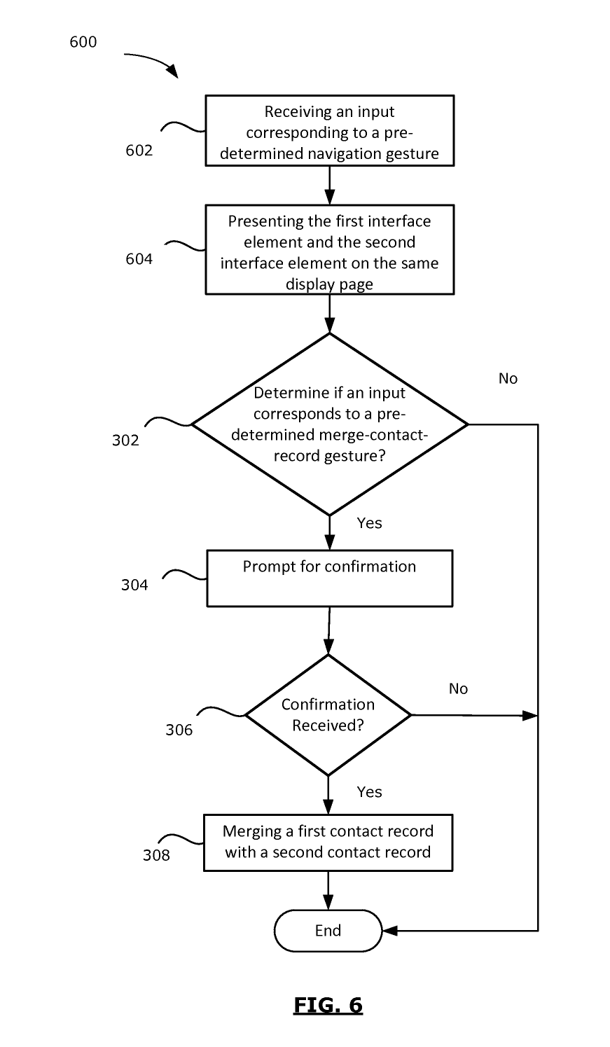

Reference is now made to FIG. 6, which illustrates a flowchart of an example method 600 of merging contact. The electronic device 201 may be configured to perform the method 600 of FIG. 6. In at least some example embodiments, the processor 240 of the electronic device 201 is configured to perform the method 600 of FIG. 6. One or more applications 224 or modules on the electronic device 201 may contain computer readable instructions which cause the processor 240 of the electronic device 201 to perform the method 600 of FIG. 6. In at least some example embodiments, the contact manager 226 stored in memory of the electronic device 201 is configured to perform the method 600 of FIG. 6. More particularly, the contact manager 226 may contain computer readable instructions which, when executed, cause the processor 240 to perform the method 600 of FIG. 6. It will be appreciated that the method 600 of FIG. 6 may, in at least some example embodiments, be provided by other software applications or modules apart from those specifically discussed above, such as the operating system 222. Accordingly, any features which are referred to as being performed by the electronic device 201 may be performed by any one or more of the software applications or modules referred to above or other software modules.

In at least some example embodiments, at least some of the method 600 of FIG. 6 may be performed by or may rely on other applications 224 or modules which interface with the contact manager 226. For example, the contact manager 226 may be equipped with an application programming interface (API) which allows other software applications 224 or modules to access features of the contact manager 226.

Referring now to FIG. 6, in one display state, the first interface element 370a and the second interface element 370b are not presented on a same display page of the touchscreen display 204. For example, the first interface element 370a associated with the first contact identifier 375a (“Ben”) may not appear on the same display page as the second interface element 370b associated with the second contact identifier 375b (“Ben Vo”) because of the display arrangement of the contact identifiers 375a, 375b, 375c, 375d (for example, the contact identifiers 375a, 375b, 375c, 375d may be arranged alphabetically), and/or the display configuration of the display page (for example, the display page may be configured to only display a set number of contact identifiers).

At 602, the contact manager 226 receives an input via the touchscreen display corresponding to a pre-determined multiple-contact-locator navigation gesture. The multiple-contact-locator navigation gesture includes a selection of the first interface element (e.g. the first user interface element may be selected via the touchscreen display). In at least some example embodiments, in response to such selection, the first interface element 370a is maintained at the same position on the touchscreen display 204 during the multiple-contact-locator navigation gesture. Furthermore, in at least some example embodiments, selecting the first interface element 370a may graphically change the display of the first interface element 370a, and/or the associated first contact identifier 375a displayed on the touchscreen display 204. For example, a selection of the first interface element 370a may graphically bolden, color, highlight or outline, the first interface element 370a and/or the associated first contact identifier 375a. The input may be received in the manner described above with reference to 302 of FIG. 3.

In at least some example embodiments, the contact manager 226 may determine that the received input corresponds to a multiple-contact-locator navigation gesture. In such example embodiments, the determination may be made in the manner also described above with reference to 302 of FIG. 3.

In at least some example embodiments, the multiple-contact-locator navigation gesture may be a multi-touch navigation gesture. In such example embodiments, the multi-touch navigation gesture may include touching with at least a first finger 402a the first interface element 370a, and scrolling with a second finger 402b for locating the second interface element 370b. The first finger 402a is placed on the first interface element 370a for selecting the first interface element 370a. The second finger 402b is used to perform a scrolling function to locate the second interface element 370b. The scrolling function may change the display state. That is, different display pages may be displayed including different list of interface elements (associated with different contact records) for each scroll. In at least some example embodiments, the scrolling function may be performed by a swiping movement. The second finger 402b may be swiped across the touchscreen display 204. The first interface element 370a is maintained at the same position on the touchscreen display 204 while the scrolling function is performed by the second finger 402b. The scrolling may be stopped when the second interface element 370b is located. That is, the first interface element 370a and the second interface element 370b are displayed on the same display page.

Next, at 604, in response to receiving the multiple-contact-locator navigation gesture, the contact manager 226 presents the first interface element 370a and the second interface element 370b on the same display page of the touchscreen display 204. For example, the first interface element 370a associated with the first contact identifier 375a (“Ben”) appears on the same display page as the second interface element 370b associated with the second contact identifier 375b (“Ben Vo”). By appearing on the same display page, the first interface element 370a and the second interface element 370b may be selectable to perform a merge-contact-record gesture. In at least some example embodiments, selecting the second interface element 370b may graphically change the display of the second interface element 370b, and/or the associated second contact identifier 375b displayed on the touchscreen display 204. For example, a selection of the second interface element 370b may graphically bolden, color, highlight or outline, the second interface element 370b and/or the associated second contact identifier 375b.

In at least some example embodiments, the multiple-contact-locator navigation gesture and the merge-contact-record gesture may be the same gesture. That is, in some example embodiments, the multiple-contact-locator navigation gesture completes when a second interface element is selected and, at that point, the contact records associated with the first interface element and the second interface element may be merged.

In other example embodiments, the multiple-contact-locator navigation gesture and the merge-contact-record gesture may be independent gestures. The multiple-contact-locator navigation gesture may be used for causing two contact records to be displayed on the same page and the merge-contact-record gesture may be used for causing two contact records to be merged.

In at least some example embodiments, after presenting the first interface element 370a and the second interface element 370b on the same display page, the method 600 includes the additional steps of 302, 304, 306 and 308 which are discussed in greater detail above with reference to FIG. 3.

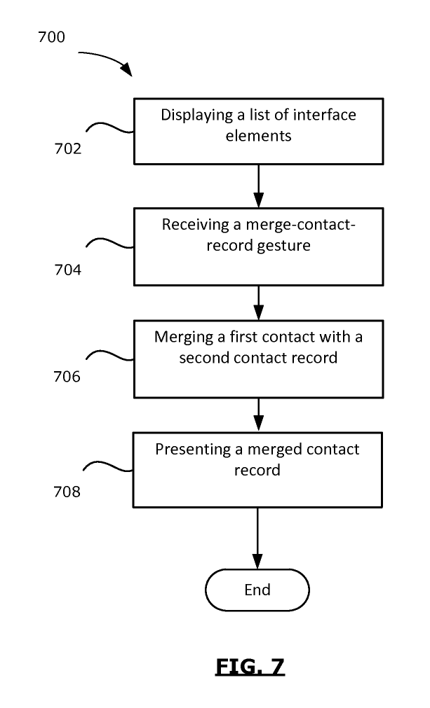

Referring now to FIG. 7, an example method of receiving a merged-contact-record gesture is illustrated in flowchart form. The electronic device 201 may be configured to perform the method 700 of FIG. 7. In at least some example embodiments, the processor 240 of the electronic device 201 is configured to perform the method 700 of FIG. 7. One or more applications 224 or modules on the electronic device 201 may contain computer readable instructions which cause the processor 240 of the electronic device 201 to perform the method 700 of FIG. 7. In at least some example embodiments, the contact manager 226 stored in memory of the electronic device 201 is configured to perform the method 700 of FIG. 7. More particularly, the contact manager 226 may contain computer readable instructions which, when executed, cause the processor 240 to perform the method 700 of FIG. 7. It will be appreciated that the method 700 of FIG. 7 may, in at least some example embodiments, be provided by other software applications or modules apart from those specifically discussed above, such as the operating system 222. Accordingly, any features which are referred to as being performed by the electronic device 201 may be performed by any one or more of the software applications or modules referred to above or other software modules.

In at least some example embodiments, at least some of the method 700 of FIG. 7 may be performed by or may rely on other applications 224 or modules which interface with the contact manager 226. For example, the contact manager 226 may be equipped with an application programming interface (API) which allows other software applications 224 or modules to access features of the contact manager 226.

Referring to FIG. 7, at 702, the contact manager 226 displays a list of interface elements 370a, 370b, 370c, 370d including a first interface element 370a and a second interface element 370b. The interface elements 370a, 370b, 370c, 370d may be displayed as a list, and may be each associated with a contact identifier 375a, 375b, 375c, 375d. That is, the first interface element 370a is associated with a first contact identifier 375a, the second interface element 370b is associated with a second contact identifier 375b, etc. The contact identifiers 375a, 375b, 375c, 375d may be user defined, and in at least some example embodiments, may be identified as a personal name or a company name.

Next at 704, the contact manager 226 receives a merge-contact-record gesture. The merge-contact-record gesture is a multi-touch gesture which includes a selection of the first interface element 370a and the second interface element 370b. In at least some example embodiments, the multi-touch gesture may include a pinching movement. In such example embodiments, the pinching movement may be a movement which starts with at least two fingers 402a, 402b spaced apart and ends with the two fingers 402a, 402b almost touching or touching, with little or no space between the two fingers 402a, 402b. In such example embodiments, a first finger 402a may be placed on the first interface element 370a and a second finger 402b may be placed on the second interface element 370b. The first finger 402a and the second finger 402b are then moved closer together until there is little or no space between them. In at least some example embodiments, the pinching movement may be a movement which starts with at least two fingers 402a, 402b spaced apart and ends with the two fingers 402a, 402b relatively closer to each other than when starting the movement. In such example embodiments, the first finger 402a may be placed on the first interface element 370a and the second finger 402b may be placed on the second interface element 370b. The first finger 402a and the second finger 402b are then moved relatively closer to each other than when starting the movement.

In at least some example embodiments, the contact manager 226 may determine that it received a merge-contact-record gesture. In such example embodiments, the determination may be made in the manner described above with reference to 302 of FIG. 3.

In response to receiving the merge-contact-record gesture, at 706, the contact manager 226 merges a first contact record 300a associated with the first interface element 370a with a second contact record 300b associated with the second interface element 370b forming a merged contact record 300ab. In at least some example embodiments, the merging function includes selectively using data from the first contact record 300a and the second contact record 300b based on pre-determined rules.

The merged contact record 300ab is then, at 708, presented on the touchscreen display 204. The merged contact record 300ab may be presented on the same display page as the new list of interface elements 370ab, 370c, 370d, 370e and/or on a different display page than the new list of interface elements 370ab, 370c, 370d, 370e.

While the present application is primarily described in terms of methods, a person of ordinary skill in the art will understand that the present application is also directed to various apparatus such as an electronic device 201 including a mobile communications device. The electronic device 201 includes components for performing at least some of the aspects and features of the described methods, which may be by way of hardware components (such as the memory 244 and/or the processor 240), software or any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the described methods. It is understood that such apparatus, articles of manufacture, and computer data signals also come within the scope of the present application.

The term “computer readable medium” as used herein means any medium which can store instructions for use by or execution by a computer or other computing device including, but not limited to, a portable computer diskette, a hard disk drive (HDD), a random access memory (RAM), a read-only memory (ROM), an erasable programmable-read-only memory (EPROM) or flash memory, an optical disc such as a Compact Disc (CD), Digital Versatile Disc (DVD) or Blu-ray™ Disc, and a solid state storage device (e.g., NAND flash or synchronous dynamic RAM (SDRAM)).

Example embodiments of the present application are not limited to any particular operating system, system architecture, mobile device architecture, server architecture, or computer programming language.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A method implemented by a processor of an electronic device having a touchscreen display, the method comprising:
determining if an input via the touchscreen display corresponds to a pre-determined merge-contact-record gesture that is a multi-touch gesture that includes a selection of a first interface element and a second interface element, the first interface element being associated with a first contact record and the second interface element being associated with a second contact record; and
if the input corresponds to the pre-determined merge-contact-record gesture, merging the first contact record with the second contact record.

2. The method of claim 1, wherein the multi-touch gesture is a pinching movement.

3. The method of claim 2, wherein the pinching movement is a movement which starts with at least two fingers spaced apart and ends with the two fingers touching with no space between the two fingers.

4. The method of claim 2, wherein the pinching movement is a movement which starts with at least two fingers spaced apart and ends with the two fingers relatively closer than when starting the movement.

5. The method of claim 3, wherein the pinching movement is a movement of each of the two fingers.

6. The method of claim 1, wherein the multi-touch gesture includes a selection of three or more interface elements associated with three or more contact records, and wherein if the input corresponds to the pre-determined merge-contact-record gesture, the three or more contact records are merged.

7. The method of claim 1, wherein the multi-touch gesture is a three finger closing movement which begins with three fingers spaced apart and ends with the three fingers touching with no space between the three fingers.

8. The method of claim 1, wherein the multi-touch gesture is a three finger closing movement which begins with three fingers spaced apart and ends with the three fingers relatively closer than when starting the movement.

9. The method of claim 1, wherein, in one display state, the first interface element and the second interface element are not presented on a same display page of the touchscreen display, and the method further comprising:
receiving an input via the touchscreen display corresponding to a pre-determined multiple-contact-locator navigation gesture, wherein the first interface element is maintained at the same position on the touchscreen display during the pre-determined multiple-contact-locator navigation gesture; and
in response to receiving the pre-determined multiple-contact-locator navigation gesture, presenting the first interface element and the second interface element on the same display page of the touchscreen display.

10. The method of claim 9, wherein the pre-determined multiple-contact-locator navigation gesture is a multi-touch navigation gesture.

11. The method of claim 10, wherein the multi-touch navigation gesture includes touching with at least a first finger the first interface element and scrolling with a second finger for locating the second interface element.

12. The method of claim 1, wherein merging includes selectively using data from the first contact record and the second contact record based on one or more pre-determined rules.

13. The method of claim 1, further comprising:
storing the merged contact record in a data store associated with a memory of the electronic device.

14. The method of claim 1, further comprising, prior to merging:
in response to determining that the input corresponds to the pre-determined merge-contact-record gesture, presenting a prompt via the touchscreen display requesting confirmation to merge the first contact record and the second contact record; and
if confirmation is received from the touchscreen display, merging the first contact record with the second contact record.

15. An electronic device comprising:
a memory;
a touchscreen display;
a processor coupled with the memory and the touchscreen display, the processor being configured to:
determine if an input via the touchscreen display corresponds to a pre-determined merge-contact-record gesture that is a multi-touch gesture that includes a selection of a first interface element and a second interface element, the first interface element being associated with a first contact record and the second interface element being associated with a second contact record; and
if the input corresponds to the pre-determined merge-contact-record gesture, merge the first contact record with the second contact record.

16. The electronic device of claim 15, wherein the electronic device is a mobile communication device.

17. A method implemented by a processor of an electronic device having a touchscreen display, comprising:
displaying a list of interface elements including a first interface element and a second interface element;
receiving a merge-contact-record gesture wherein the merge-contact-record gesture is a multi-touch gesture that includes a selection of the first interface element and the second interface element;
merging a first contact record associated with the first interface element with a second contact record associated with the second interface element; and
presenting a merged contact record.

18. The electronic device of claim 15, wherein the multi-touch gesture is a pinching movement.

19. The electronic device of claim 18, wherein the pinching movement is a movement which starts with at least two fingers spaced apart and ends with the two fingers touching with no space between the two fingers.

20. The electronic device of claim 18, wherein the pinching movement is a movement which starts with at least two fingers spaced apart and ends with the two fingers relatively closer than when starting the movement.
